(19) United States
(12) Patent Application Publication
(10) Pub. No.: US 2025/0205635 A1
(43) Pub. Date: Jun. 26, 2025

(54) BIOMASS ENERGY GENERATION

(71) Applicants: RICARDO UK LIMITED, West Sussex (GB); BLUEBOX ENERGY LTD, Alverstoke Gosport (GB); RICARDO-AEA LIMITED, West Sussex (GB)

(72) Inventors: Jonathon McGuire, Alverstoke Gosport (GB); Flavien Bérard, Alverstoke Gosport (GB); Naser Odeh, Didcot Oxfordshire (GB); Gareth Edward Milton, West Sussex (GB)

(73) Assignees: RICARDO UK LIMITED, West Sussex (GB); BLUEBOX ENERGY LTD, Alverstoke Gosport (GB); RICARDO-AEA LIMITED, West Sussex (GB)

(21) Appl. No.: 18/847,522

(22) PCT Filed: Mar. 8, 2023
(86) PCT No.: PCT/GB2023/050555

§ 371 Date: Sep. 16, 2024

(30) Foreign Application Priority Data
Mar. 16, 2022 (GB) 2203666.9

(51) Int. Cl. B01D 53/14; B01D 53/04; B01D 53/34; B01D 53/62; F23K 1/04

(52) U.S. Cl. CPC B01D 53/1475; B01D 53/04; B01D 53/1493; B01D 53/343; B01D 53/62; F23K 1/04; B01D 2252/204; B01D 2257/504; B01D 2257/80; B01D 2258/0283; F23K 2201/20

(57) ABSTRACT

This disclosure relates to a flue gas treatment system for a biomass energy generation system, the flue gas treatment system comprising: a circulation of solvent for absorbing carbon dioxide from the flue gas; a heat exchanger located along the flow path of the solvent, for heating the solvent; and a heat transfer fluid, wherein the heat transfer fluid is arranged to circulate between the heat exchanger and the biomass energy generation system, such that the heat transfer fluid absorbs heat from a heated fluid of the biomass energy generation system and transfers the heat to the circulation of solvent via the heat exchanger. This disclosure also relates to a feedstock drier for a biomass energy generation system, and a biomass energy generation system.

### FIELD OF INVENTION

This disclosure relates to biomass energy generation systems, more specifically to pyrolysis-based combined heat and power systems. This disclosure also relates to a feedstock drier and a flue gas treatment system, for removing carbon dioxide, for a biomass energy generation system.

### BACKGROUND

Biomass energy generation systems use plant or animal material, such as wood, as a feedstock to produce energy. One particular type of biomass energy generation system, a pyrolysis energy generation system, produces energy by pyrolysis of the feedstock. The energy generated in the biomass energy generation system can be used to provide a heat output, a power (i.e. electricity) output, or a combined heat and power output.

Existing biomass energy generators produce significant amounts of waste heat, which is typically released in the form of hot flue gas or hot air emitted from a stack of the generator.

This waste heat reduces the overall efficiency of the system, which in turn increases the carbon dioxide emissions of the system per unit of energy produced.

Furthermore, while the pyrolysis process leaves some of the feedstock carbon in solid form, significant amounts of the carbon is released as carbon dioxide in the exhaust flue gas. Existing processes for carbon dioxide removal require significant amounts of energy, potentially offsetting the benefits of removing the carbon dioxide.

The present invention seeks to provide improvements in the efficiency of biomass energy generators and in the efficiency of the removal of carbon dioxide from the exhaust flue gas.

### SUMMARY OF THE INVENTION

Aspects and embodiments of the present invention are set out in the appended claims. These and other aspects and embodiments of the invention are also described herein.

According to at least one aspect described herein, there is provided a flue gas treatment system for a pyrolysis-based biomass energy generation system, the flue gas treatment system comprising: a circulation of solvent for absorbing carbon dioxide from the flue gas; a heat exchanger located along the flow path of the solvent, for heating the solvent; and a heat transfer fluid, wherein the heat transfer fluid is arranged to circulate between the heat exchanger and the biomass energy generation system, such that the heat transfer fluid absorbs heat from a heated fluid of the biomass energy generation system and transfers the heat to the circulation of solvent via the heat exchanger. Therefore, the flue gas treatment system makes use of heat from the energy generation system that otherwise might be wasted, thereby increasing the efficient use of the generated energy, and increasing the amount of carbon dioxide removed per unit of energy output by the energy generation system.

Preferably, the heated fluid is a hot air stream for driving a turbine of the biomass energy generation system, more preferably wherein the heat transfer fluid is arranged to absorb heat from the air stream downstream of the turbine. The hot air may be discharged from the turbine (after having driven the turbine) before transferring heat to the heat transfer fluid. This arrangement means that heat is not extracted from the hot air stream until after it drives the turbine, thereby prioritising the use of the hot air in electricity generation before extracting heat to power the flue gas treatment system.

Preferably, the heated fluid of the biomass energy generation system is a flue gas stream from a biomass reactor of the biomass energy generation system, more preferably wherein the heat transfer fluid is arranged to absorb heat from the flue gas stream downstream of a flue gas heat exchanger for providing a heat output. This arrangement means that heat is not extracted from the hot flue gas stream before heat is extracted to provide a heat output of the generator, thereby prioritising the use of the hot flue gas in providing a heat output before extracting heat to power the flue gas treatment system.

Preferably, the heat transfer fluid is arranged to absorb heat from the heated fluid of the biomass energy generation system via a further heat exchanger located along the flow path of the heated fluid, and wherein the heat transfer fluid is arranged to circulate between the heat exchanger of the flue gas treatment system and the further heat exchanger. The heat exchangers provide for efficient transfer of heat between the fluids.

Preferably, the heat exchanger located along the flow path of the solvent is a reboiler for heating the solvent.

Preferably, the heat transfer fluid is steam, and: the reboiler is arranged to receive steam from the further heat exchanger located along the flow path of the heated fluid of the biomass energy generation system, and to transfer heat from the steam to the solvent, thereby forming a condensate from the steam; and the further heat exchanger located along the flow path of the heated fluid of the biomass energy generation system is arranged to receive the condensate from the reboiler, and to transfer heat from the heated fluid of the biomass energy generation system to the condensate, thereby forming the steam. The steam-condensate cycle between the steam generator and the reboiler provides effective transfer of heat due to the high heat capacity of water and the characteristic of saturated steam in maintaining a constant temperature during heat transfer consuming latent heat of vaporisation. Such constant temperature prevents damage to the solvent.

Preferably, the solvent is an amine. However, it should be understood that other solvents could be used. Examples of other potential solvents include carbonates (such as potassium carbonate) and ammonia. Amine based solvents are effective at absorbing carbon dioxide and are readily available. According to another aspect described herein, there is provided a feedstock drier for a biomass energy generation system, the feedstock drier comprising:

means for providing an air flow to a feedstock for the biomass energy generation system; at least one heat exchanger located along the air flow path; and at least one coolant arranged to flow between the at least one heat exchanger and at least one component of a gas treatment system for the biomass energy generation system, wherein the at least one coolant is arranged to absorb heat from the at least one component, and wherein the at least one heat exchanger is arranged to transfer the heat from the coolant to the air flow. Therefore, the feedstock drier makes use of heat from the energy generation system or flue gas treatment system that otherwise might be wasted, thereby increasing the efficient use of the generated energy, and increasing the amount of carbon dioxide removed per unit of energy output by the energy generation system.

Preferably, the gas treatment system is a flue gas treatment as aforementioned.

Preferably, the at least one component comprises a flue gas scrubber, and wherein the coolant is arranged to cool the scrubber by absorbing heat from the scrubber.

Preferably, the flue gas scrubber is located on the flue gas flow path downstream of power and/or heat generation components of the biomass energy generation system.

Preferably, the at least one component comprises a trim cooler in an absorption cycle for treating flue gas from the biomass energy generation system, and wherein the coolant is arranged to cool the trim cooler by absorbing heat from the trim cooler.

Preferably, the at least one component comprises a reflux condenser in an absorption cycle for treating flue gas from the biomass energy generation system, and wherein the coolant is arranged to cool reflux condenser by absorbing heat from the reflux condenser.

Preferably, the at least one component comprises multiple components (such as two or more of the flue gas scrubber, trim cooler, and reflux condenser as aforementioned), and: the at least one heat exchanger comprises a separate heat exchanger for each of the components, and/or the at least one coolant comprises a separate coolant for each of the components. Preferably, the heat exchangers are arranged in order of their operating temperatures or of the temperatures of the components they cool, preferably from hottest to coolest along the air stream. In this way, efficient transfer of heat to the air stream is promoted.

Preferably, the means for providing an air flow to the feedstock comprises a fan. The fan is preferably powered by electricity generated by the generator; the use of a fan minimises this parasitic power consumption.

Preferably, the at least one coolant is water. Water provides for effective heat transfer due to its high heat capacity.

According to another aspect described herein, there is provided a biomass energy generation system comprising: a biomass reactor; a turbine heat exchanger; and a flue gas heat exchanger, wherein the turbine heat exchanger is configured to transfer heat from the flue gas to a working fluid for driving a turbine to generate electricity; and wherein the flue gas heat exchanger is located along the flow path of the flue gas, downstream of the turbine heat exchanger, and is configured to transfer heat from the flue gas to a heat output of the system. Therefore, the system makes use of heat from the flue gas that otherwise might be wasted by extracting this heat and transferring it to a heat output of the system, thereby increasing the efficient use of the generated energy, and reducing the carbon dioxide emissions per unit of energy output by the energy generation system.

Preferably, the system comprises a flue gas return pipe for recirculation of the flue gas back into the biomass reactor. The recirculation of a part of the flue gas back to the pyrolysis reactor provides a supply of inert gases within the pyrolysis reactor. These inert gases absorb some of the pyrolysis heat in the reactor, and also dilute the oxygen supply in the pyrolysis reactor. Both of these factors reduce the heat of the pyrolysis reaction, which thereby suppresses the production of undesirable nitrogen oxide which is produced in high temperature mixes of nitrogen and oxygen.

Preferably, the flue gas return pipe is located downstream of the flue gas heat exchanger. In this way, heat is extracted from the maximum amount of flue gas before the flue gas is diverted.

Preferably, the system comprises a pump for driving the flow of the flue gas, preferably wherein the pump is located on the flue gas flow path downstream of the flue gas heat exchanger. The pump prevents back-flow of flue gas into the reactor, which is at below atmospheric pressure.

Preferably, the system comprises a working fluid heat exchanger located along the flow path of the working fluid, the working fluid heat exchanger configured to transfer heat from the working fluid to a heat output of the system. In this way, a further heat output from the 5 system is provided, separate from the output of heat extracted from the flue gas.

Preferably, the working fluid heat exchanger is located along the flow path of the working fluid downstream of the turbine. This arrangement means that heat is not extracted from the working fluid before the working fluid is used to drive the turbine, thereby prioritising the drive of the turbine before extracting heat to provide a heat output of the system.

Preferably, the system comprises a carbon dioxide processing system, wherein the carbon dioxide processing system is arranged to receive a gas stream comprising carbon dioxide removed from the flue gas, and comprises means for dehydrating the gas stream, preferably wherein the means for dehydrating the gas stream comprises at least one dehydrator column for removing water vapour from the gas stream, preferably by adsorption.

Preferably, the carbon dioxide processing system comprises a compressor downstream of the means for dehydrating, the compressor configured to compress the carbon dioxide, and optionally a refrigerator downstream of the compressor for cooling the carbon dioxide to a liquid state.

The carbon dioxide processing system enables the use of the carbon dioxide produced in the system to be used, for example in an industrial process, thus minimising the release of carbon dioxide to the atmosphere and also reducing the waste products of the system.

According to another aspect disclosed herein, there is provided a biomass energy generation system comprising: the flue gas treatment system as aforementioned, and/or the feedstock drier as aforementioned, preferably wherein the biomass energy generations system is as aforementioned. In combination, the waste heat recovery aspects of the various systems provide for particularly effective waste heat recovery.

Preferably, the biomass energy generation system is a pyrolysis energy generation system. Pyrolysis of certain feedstocks can produce biochar which acts as a carbon sink and which has further uses, thus reducing the true waste products of the system.

As used herein, the term ‘flue gas’ preferably refers to the collection of gases produced as a result of the reaction(s) taking place in the biomass reactor, where the composition of the flue gas depends on the substance used in the reactor.

As used herein, the term ‘heat transfer’ or related terms preferably refers to a direct or indirect transfer of heat. For example, reference to the transfer of heat from the flue gas to the working fluid includes a direct transfer or heat from one fluid to the other or an indirect transfer of heat through an intermediate component or fluid.

As used herein, the term “pyrolysis-based (biomass) energy generation system” or related terms preferably refers to an energy generation system which employs pyrolysis of a feedstock to generate energy, for example using a pyrolysis reactor.

Any feature in one aspect of the invention may be applied to other aspects of the invention, in any appropriate combination. In particular, method aspects may be applied to apparatus aspects, and vice versa. It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly. Any apparatus feature described herein may also be provided as a method feature, and vice versa. As used herein, means plus function features may be expressed alternatively in terms of their corresponding structure such as a suitably programmed processor and associated memory.

One or more aspects will now be described, by way of example only and with reference to the accompanying drawings, in which:

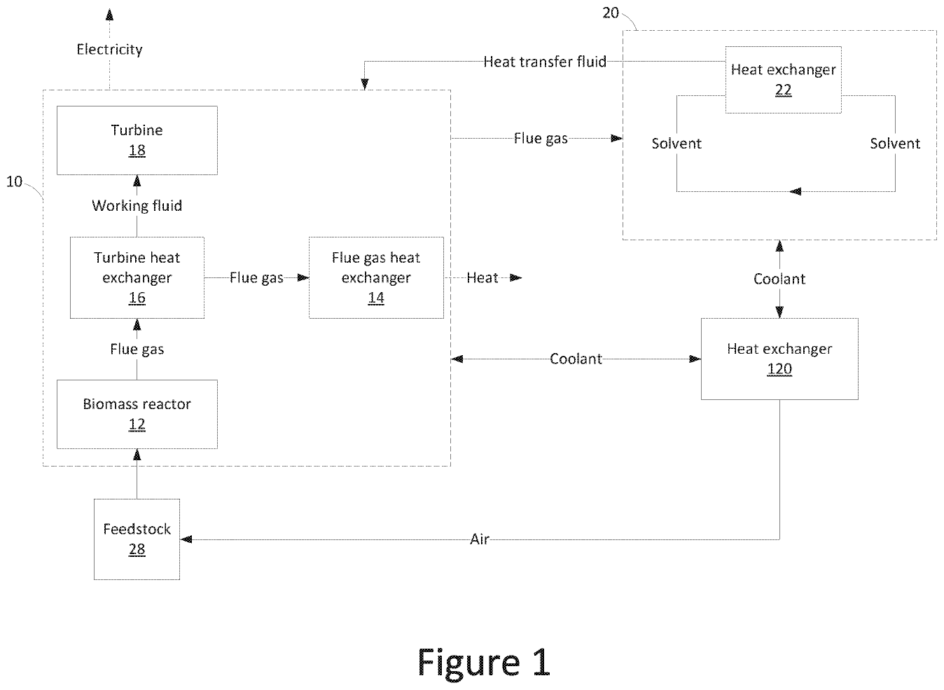

FIG. 1 is a block diagram of an exemplary biomass energy generation system and a flue gas treatment system of the present disclosure;

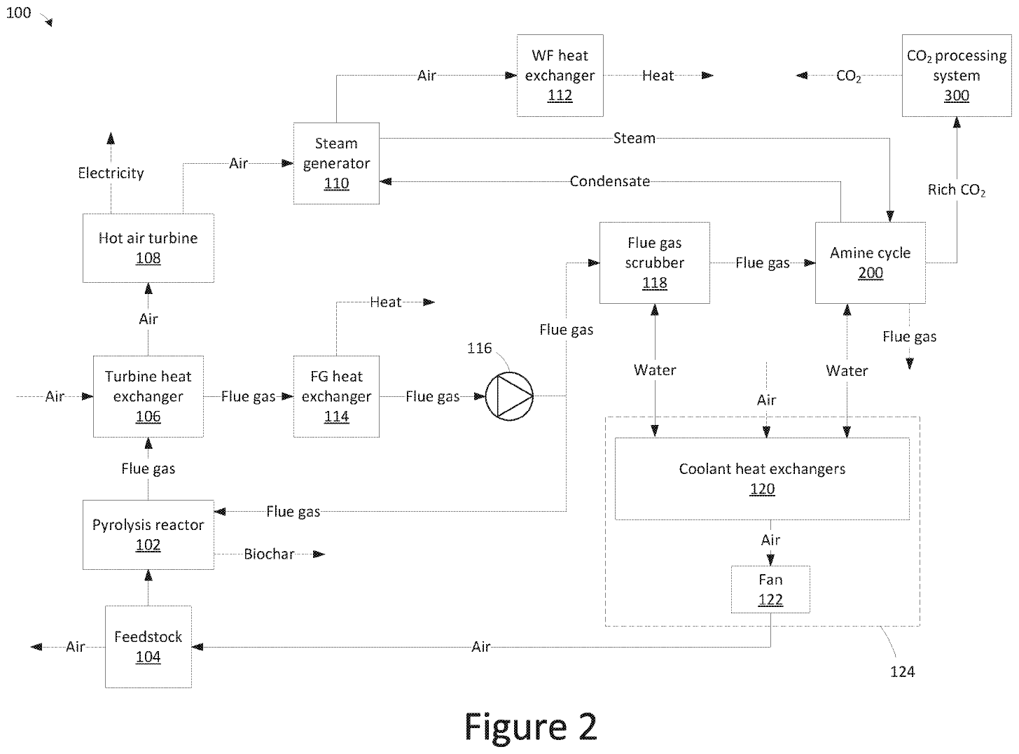

FIG. 2 is a block diagram of another exemplary biomass energy generation system along with an absorption cycle which provides a flue gas treatment system and an exemplary feedstock drier;

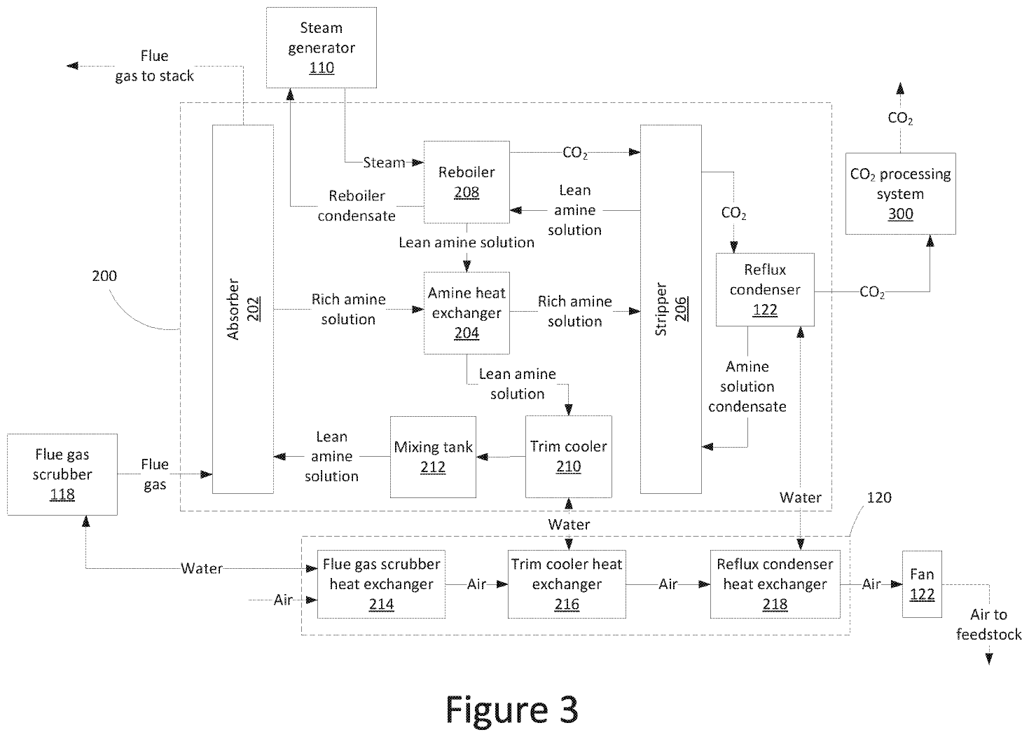

FIG. 3 is a block diagram of the absorption cycle and the feedstock drier for the biomass energy generation system; and

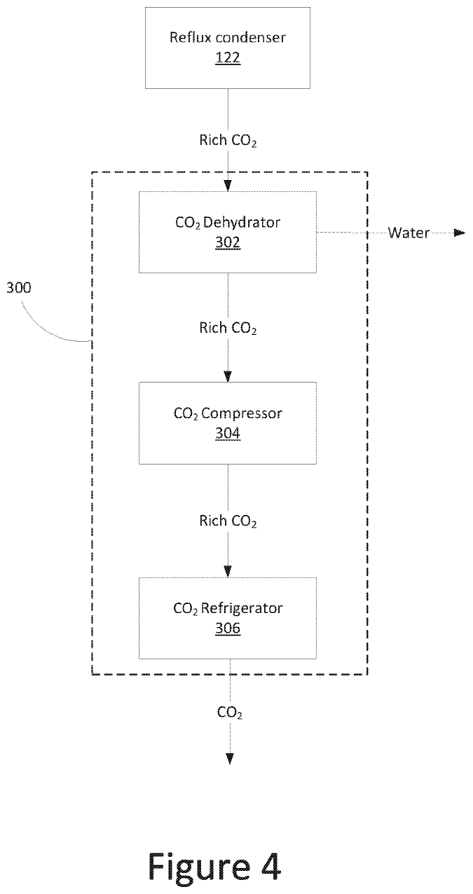

FIG. 4 is a block diagram of an exemplary carbon processing system for the biomass energy generation system.

### DETAILED DESCRIPTION

Exemplary embodiments of the biomass energy generation system, the flue gas treatment system, and the feedstock drier are described below.

In particular, an exemplary biomass energy generation system, flue gas treatment system, and feedstock drier are described in overview with reference to FIG. 1. More detailed examples of these systems are described in more detail with reference to FIGS. 2 to 4, where the biomass energy generation system is described for example as a pyrolysis energy generation system which provides a combined heat and power output. In particular, a more detailed exemplary biomass energy generation system, specifically a pyrolysis energy generation system, is described below with reference to FIG. 2. An exemplary flue gas treatment system for treating the flue gas resulting from the pyrolysis process using waste heat is described with reference to FIG. 3, along with an exemplary feedstock drier for the biomass energy generation system which recovers and utilises waste heat to dry the feedstock. A carbon processing system for processing carbon dioxide removed from the flue gas is described below with reference to FIG. 4.

### System Overview

FIG. 1 is a block diagram of an exemplary biomass energy generation system and a flue gas treatment system of the present disclosure.

In overview, the biomass energy generation system 10 (also referred to as the biomass generator, or simply the generator) comprises: a biomass reactor 12; a turbine heat exchanger 16; and a flue gas heat exchanger 14. Broadly, the turbine heat exchanger 16 is configured to transfer heat from a flue gas from the biomass reactor 12 (i.e. a flue gas produced from the biomass reaction, or from a further reaction using a product of the biomass reaction) to a working fluid for driving a turbine 18 to generate electricity. The flue gas heat exchanger 14 is located along the flow path of the flue gas, downstream of the turbine heat exchanger 16, and is configured to transfer heat from the flue gas to a heat output of the system. In this way, the heat remaining in the flue gas after it has passed heat on to the working fluid is recovered via the flue gas heat exchanger. This heat might otherwise have been wasted by being carried by the flue gas out of the system, such as via a flue gas stack. Therefore, this waste heat recovery improves the efficiency of the energy generation system.

Separate from the biomass energy generation system 10, a flue gas treatment system 20 is provided for treating the flue gas from the biomass energy generation system 10. The flue gas treatment system 20 is shown receiving flue gas from the biomass energy generation system 10 described above, however it should be understood that the flue gas treatment system 20 could be used to treat flue gas from any other biomass energy generation system. In overview, the flue gas treatment system 20 comprises a circulation of solvent for absorbing carbon dioxide from the flue gas; a heat exchanger 22 located along the flow path of the solvent, for heating the solvent; and a heat transfer fluid. Broadly, the heat transfer fluid is arranged to circulate between the heat exchanger 22 and the biomass energy generation system 10, such that the heat transfer fluid absorbs heat from a heated fluid of the biomass energy generation system 10 (for example, the working fluid for driving the turbine, or the flue gas stream from the biomass reactor) and transfers the heat to the circulation of solvent via the heat exchanger 22. In this way, heat in the biomass energy generation system, which otherwise might be wasted, is recovered and used to heat the solvent in the flue gas treatment system 20.

Furthermore, there is also provided a feedstock drier for a biomass energy generation system, such as the system 10 described above. In overview, the feedstock drier comprises means for providing an air flow to a feedstock 28 for the biomass energy generation system; at least one heat exchanger 26 located along the air flow path; and at least one coolant arranged to flow between the at least one heat exchanger 26 and at least one component of the biomass energy generation system (such as a flue gas scrubber) or of a gas treatment system for the biomass energy generation system (such as a trim cooler or reflux condenser), wherein the at least one coolant is arranged to absorb heat from the at least one component, and wherein the at least one heat exchanger 26 is arranged to transfer the heat from the coolant to the air flow. In this way, heat in the biomass energy generation system and/or the flue gas treatment system, which otherwise might be wasted, is recovered and used to dry the feedstock for the biomass reactor.

### Combined Heat and Power Generation

FIG. 2 is a block diagram of another exemplary biomass energy generation system 100 of the present disclosure. Solid arrowed lines are drawn between blocks of the diagram, which indicate an input or output flow to or from the various blocks within the system. Dashed arrowed lines are drawn to or from certain blocks indicating an input from, or output to, outside the system, for example from or to the outside environment. Blocks indicated in the drawings as being separate are intended to indicate separate functions, and do not necessarily refer to those functions being carried out be structurally separate components; for example the functions indicated by certain blocks may in practice be provided be a single component.

The biomass generator 100 comprises a pyrolysis reactor 102 (analogous to the biomass reactor 12 of FIG. 1). The pyrolysis reactor 102 is configured to contain a pyrolysis reaction. The pyrolysis reactor 102 takes a biomass feedstock 104, which in this example is wood, preferably waste wood such as waste timber, and burns the feedstock 104 in the presence of a restricted amount of oxygen to produce biochar and pyrolysis gas (also known as syngas) in a first stage of the reactor. The syngas is then combusted—for example, in a FLOX combustion (flameless oxidation) reaction—in a second stage of the reactor, producing flue gas.

The biochar produced in the pyrolysis reaction contains a significant proportion of the carbon originating in the biomass, in a stable form. Therefore, the biochar acts a carbon sink, sequestering a proportion of the carbon produced in the pyrolysis reaction and thus restricting the amount of carbon dioxide released into the atmosphere. Furthermore, the biochar has other uses, such as in farmland spread (CO₂ sequestration), soil enhancement (when combined with compost) and reduced use of fertilisers. Therefore, the biochar produced in the generator is not wasted.

The second stage of the reactor has an in-built high temperature turbine heat exchanger 106 (analogous to the turbine heat exchanger 16 of FIG. 1) which is arranged to transfer heat from the flue gas to a working fluid for driving a turbine. In other examples, the turbine heat exchanger may be separate from, and downstream of, the pyrolysis reactor. In this example, the working fluid is a stream of air which is taken from the external environment. The turbine heat exchanger 106 transfers heat from the flue gas to the air stream, and this heated air is used to drive a hot air turbine 108 (analogous to the turbine 18 of FIG. 1) in order to generate electrical power. The electrical power is output through an electrical power output to an external electrical power demand, as indicated by the dashed ‘electricity’ line. The hot air turbine 108 may also comprise means for compressing the heated air in a first stage of the turbine, before the compressed heated air drives rotation of the turbine in a second stage.

The hot air, having passed through the hot air turbine 108, is routed through a steam generator 110, which is explained below with reference to FIG. 3. Having passed through the steam generator 110, the hot air is used for an external heat demand. As the air stream from the turbine is clean, the hot air itself may be supplied outside of the system to provide the heat output (e.g. to supply the hot air to a building to heat the building or to supply the hot air for use in an industrial process). Alternatively, the hot air is routed through a working fluid (“WF”) heat exchanger 112 such that heat from the hot air is transferred to a coolant (e.g. water) which is then transferred outside the system (such as to a radiator) to provide the heat output. Alternatively, the system may provide both heat outputs; in this case, the heat output from the working fluid heat exchanger provides one heat output, and the hot air itself provides another heat output.

The flue gas from the pyrolysis process is routed, after having passed through the turbine heat exchanger 106 via which heat is transferred from the flue gas to the air stream, to a flue gas (“FG”) heat exchanger 114 (analogous to the flue gas heat exchanger 14 of FIG. 1). The flue gas heat exchanger 114 is arranged to transfer heat from the flue gas to a coolant (such as water) which is transferred outside the system to provide an additional heat output from the system.

Therefore, the system provides combined heat and power by way of three energy outputs: an electricity output from the hot air turbine 108, a first heat output from the working fluid heat exchanger 112, and a second heat output from the flue gas heat exchanger 114. There is also optionally a third heat output, which is the hot air itself after having passed through the working fluid heat exchanger 112. The heat outputs from the system are at different temperatures so can be used to satisfy different heat demands. In particular, the heat working fluid heat exchanger 112 provides a heat output of approximately 70 to 80 degrees Celsius, whereas the heat output provided by the flue gas heat exchanger 114 is much hotter.

Advantageously, these heat outputs make use of heat that otherwise would be wasted, thereby improving the efficiency of the system, which in turn reduces the amount of carbon dioxide produced per unit energy generated by the system. In particular, the system makes use of the heat in the flue gas, extracting this heat via the flue gas heat exchanger 114 and providing a heat output; this heat from the flue gas would otherwise be wasted by being carried by flue gas out of the system via the flue gas stack. Simultaneously, heat in the working fluid (which drives the turbine 108) is also extracted via the working fluid heat exchanger 112 to provide another heat output; this heat too might otherwise be wasted.

A pump 116, which in this example is located downstream of the flue gas heat exchanger 114, pulls the flue gas from the pyrolysis reactor through the turbine heat exchanger 106 and flue gas heat exchanger 114 and then drives the flue gas along its further flow paths as described below. The pump 116 is provided because the pyrolysis reaction takes place in the reactor 102 at sub-atmospheric pressure; the pump 116 thus prevents back flow of the flue gas into the reactor 102.

The flue gas is split, downstream of the pump 116 in this example, such that a portion of the flue gas is diverted and recirculated back to the pyrolysis reactor, while the remainder of the flue gas is routed to a flue gas scrubber 118.

The recirculation of a part of the flue gas back to the pyrolysis reactor provides a supply of inert gases within the pyrolysis reactor. These inert gases absorb some of the pyrolysis heat in the reactor, and also dilute the oxygen supply in the pyrolysis reactor. Both of these factors reduce the heat of the pyrolysis reaction, which thereby suppresses the production of undesirable nitrogen oxide which is produced in high temperature mixes of nitrogen and oxygen.

The remainder of the flue gas, which is not recirculated to the pyrolysis reactor 102, is routed to the flue gas scrubber 118. The flue gas scrubber 118 treats the flue gas to remove contaminants such as sulphur dioxide, which can be formed particularly during the low temperature pyrolysis occurring during the start-up conditions of the generator, or other contaminants depending on the feedstock and pyrolysis system.

Having passed through the flue gas scrubber, the scrubbed flue gas is routed to and processed by a carbon dioxide absorption cycle 200 to remove carbon dioxide from the flue gas as is described below with reference to FIG. 3. After the removal of carbon dioxide from the flue gas in the absorption cycle, the remaining flue gas is released from the system via a stack (e.g. a flue-gas stack) of the generator. The carbon dioxide removed in the absorption cycle is routed to a carbon dioxide processing system 300 which processes the carbon dioxide for storage and/or use as is described below with reference to FIG. 4.

As is described below in more detailed with reference to FIG. 3, the absorption cycle 200 is powered by waste heat recovered from the working fluid of the hot air turbine 108 (i.e. the hot air stream) by the stream generator 110. Heat is transferred from the steam generator 110 to the absorption cycle 200 by a circulation of steam and condensate between the steam generator 110 and a reboiler of the absorption cycle. Furthermore, as the flue gas scrubber 118 and various components of the absorption cycle 200 become hot for processing the flue gas or a heated solvent, these components are cooled by one or more coolant (e.g. water) circulations running between these components and coolant heat exchangers 120. The coolant heat exchangers 120 are arranged to transfer heat from the circulating coolant to a stream of air (taken from the external environment). The air, heated by the coolant heat exchangers 120, is driven by a fan 122 to the feedstock 104. Therefore, the coolant heat exchangers 120 and fan 122 together form a feedstock drier 124 which uses waste heat from the flue gas scrubber and the absorption cycle to dry the feedstock 104 before it is used in the pyrolysis reactor.

### Absorption Cycle

FIG. 3 is a block diagram of a carbon dioxide absorption cycle 200 which acts as a flue gas treatment system for the generator 100. The absorption cycle is arranged to receive from the flue gas scrubber 118 a gas stream comprising the portion of the flue gas which is not recirculated to the pyrolysis reactor 102. This gas stream is indicated by the ‘flue gas’ arrow leaving the flue gas scrubber 118 in FIG. 3. As described above, the flue gas scrubber 118 treats this gas stream (before it is received at the absorption cycle) to remove contaminants such as sulphur dioxide. The absorption cycle 200 then further treats this gas stream to remove carbon dioxide from the gas stream.

The absorption cycle 200 comprises a circulation of a solvent for absorbing the carbon dioxide in the gas stream. In this example the solvent is an amine solvent and is also referred to as an amine solution. The term “rich amine solution” (or solvent) is used to refer to the amine solution when it is has absorbed carbon dioxide, while the term “lean amine solution” (or solvent) is used to refer to the amine solution when the absorbed carbon dioxide has been driven out of it. It should be understood that other solvents could be used instead of an amine, such as carbonates (for example potassium carbonate) and ammonia.

The gas stream, comprising the flue gas, enters the amine cycle 200 by entering at least one absorber 202. The absorber 202 in this example is an absorber column. A lean amine solution is pumped into the absorber column 202 from a mixing tank 212, which is described below. The lean amine solution and the gas stream (comprising the flue gas) enter the absorber column 202 from opposite ends of the column 202; in particular, the lean amine solution enters the absorber column 202 at the top of the column while the gas stream enters the absorber column 202 from the bottom of the column (it is noted in this regard that FIG. 3 is a block diagram showing the interactions between the various blocks, rather than a realistic representation of the relative structural positions and locations of the various blocks and fluid flows). The lean amine solution and the gas stream therefore flow along the absorber column in opposite directions (the solution flowing from top down, and the gas stream flowing from bottom up). The absorber column 202 is arranged to cause the gas stream to flow through the amine solution, such that the carbon dioxide in the gas stream is absorbed into the amine solution. To optimise the absorption of carbon dioxide into the amine solution, the column 202 operates within a temperature range of 40 to 50 degrees Celsius and at a pressure of approximately 1.15 bar (a). The remainder of the gases in the gas stream that are not absorbed into the amine solution are discarded from the generator via a stack (e.g. a flue-gas stack) of the generator 100.

Having absorbed carbon dioxide, the amine solution (now rich amine solution, having absorbed carbon dioxide) collects in the sump of the absorber column 202 and is then pumped out of the absorber column 202 and is transferred through an amine heat exchanger 204 to a stripper 206 which in this example is a stripper column. The amine heat exchanger 204 is arranged to transfer heat from a heated lean amine solution leaving a reboiler 208 (as is described below) to the rich amine solution as it is pumped from the absorber 202 to the stripper 206. By the amine heat exchanger 204 the rich amine solution is heated to approximately 100 degrees Celsius before it is received by the stripper column 206. The heated rich amine solution is received by the stripper column 206 via an orifice plate of the stripper column 206, where carbon dioxide and water vapour that have been driven out of the amine solution by the heating from the amine heat exchanger 204 are flashed.

In this stripper column 206, the absorption reaction that took place in the absorber column is reversed such that the carbon dioxide absorbed in the amine solution is driven out of (i.e. stripped from) the amine solution in gas phase, as follows. The rich amine solution enters the stripper column 206 and flows downwards through the column 206 while heated carbon dioxide and water vapour, which enter the stripper 206 from the reboiler as described below, flow upwards through the column 206 and through the downward flowing rich amine solution. The contact between the counterflowing rich amine solution and heated carbon dioxide and water vapour causes heat to be transferred from the heated carbon dioxide and water vapour to the rich amine solution, thus heating the rich amine solution which releases the carbon dioxide that was absorbed in the solution.

The carbon dioxide released from the amine solution, along with the carbon dioxide and water vapour from the reboiler, travel upwards through the stripper column 206 and through a (preferably in-built) demister (not shown) which removes water droplets entrained in the gas stream before the gas stream exits the top of the stripper column and is routed to a reflux condenser 122. Meanwhile, the amine solution (which is now lean, having been stripped of the carbon dioxide it had absorbed) flows downwards through the stripper column 206 and collects in the sump of the stripper column 206, from where it is pumped out of the stripper column to the reboiler 208.

The reflux condenser 122 is arranged to receive the output gas stream from the top of the stripper column 206. The output gas stream from the stripper column 206 comprises predominately carbon dioxide stripped from the amine solution; however it may also contain some vapour from the amine solution which is undesirable. Therefore, the reflux condenser 122 (which in this example is a partial reflux condenser) is configured to cool the gas stream it receives from the stripper column. This cooling is achieved by the reflux condenser 122 transferring heat from the gas stream to a water coolant, as is described below with reference to the feedstock drier. This cooling results in the condensation of much of the vapour (e.g. water vapour) in the gas stream thereby partially dehydrating the gas stream and increasing the concentration of carbon dioxide in the gas stream. The resultant partially dehydrated gas stream is transferred to the carbon dioxide processing system 300, which comprises a dehydrator for removing the vapour from the gas stream that was not removed by the reflux condenser 122. The condensate formed by the reflux condenser 122 cooling the vapour in the gas stream is returned to the stripper column 206.

The lean amine solution that collects in the sump of the stripper column 206 is extracted from the column 206 by a transfer pump to the reboiler 208. In the reboiler 208, the lean amine solution is heated to approximately 115 degrees Celsius, using waste heat from the biomass energy generation system 100, as is described below. The heating of the lean amine solution in the reboiler 208 causes the release of more carbon dioxide from the amine solution. The carbon dioxide released from the solution in reboiler is returned to the stripper column 206, as indicated by the ‘CO₂’ arrow from the reboiler 208 to the stripper 206 in FIG. 3. This returned carbon dioxide flows upwards through the stripper column inducing the release of the carbon dioxide from the rich amine solution in the stripper column 206 (as described above) before this returned carbon dioxide is extracted to the reflux condenser 122 along with the released carbon dioxide as described above.

The reboiler 208 heats the lean amine solution using waste heat from biomass energy generation system 100 (the reboiler being analogous to the heat exchanger 22 of FIG. 1). In particular, a heat transfer fluid is arranged to circulate between the reboiler and the biomass energy generation system, such that the heat transfer fluid absorbs heat from a heated fluid (which in this case is the heated turbine working fluid) of the biomass energy generation system and transfers that heat to the circulating amine solution via the reboiler. In this example, this achieved by providing a steam generator 110 along the flow path of the working fluid (i.e. the hot air) which drives the turbine 108. In this example, the heat transfer fluid is water (in liquid or gas phase, i.e. steam). The reboiler 208 is arranged to receive steam from the steam generator 110, and acts as a heat exchanger along the path of the amine solution circulation to transfer heat from the steam to the amine solution, thereby to heat the amine solution to approximately 115 degrees Celsius. This heat transfer results in the condensation of the steam to form a condensate (i.e. water) which is routed to the steam generator 110. The steam generator is arranged to receive the condensate from the reboiler 208, and acts as a heat exchanger along the path of the turbine working fluid to transfer heat from the turbine working fluid to the condensate, thereby to heat the condensate to form the steam which is circulated to the reboiler as described.

The steam generator 110 is located along the path of the turbine working fluid in this example downstream of the hot air turbine but upstream of the working fluid heat exchanger 112; this arrangement is advantageous because the steam generator requires the working fluid to be relatively hot in order to be able to heat the condensate to produce the steam, whereas the working fluid heat exchanger 112 does not require the working fluid to be as hot in order to provide a heat output that is suitable for use by a heat demand.

Therefore, the steam generator 110, reboiler 208, and heat transfer fluid (i.e. the same steam and condensate) together provide a means for using waste heat from the biomass energy generation system to power the amine cycle. In this example the waste heat is taken from the turbine working fluid, however the heat in other examples could be taken from another part of the generator, such as from the flue gas, using the heat taken out of the flue gas by the flue gas scrubber 118 for example. This heat would otherwise have been wasted, and an external heat supply would be needed to provide the heat for the reboiler 208; therefore the arrangement of this system increases the efficiency of the system which in turn increases the amount of carbon dioxide removed per unit energy generated by the system.

The lean amine solution heated in the reboiler is then transferred from the boiler through the amine heat exchanger 204 to a trim cooler 210. In the amine heat exchanger 204 heat from the heated lean amine solution is transferred to the rich amine solution which is also routed through the amine heat exchanger 204 on its way between the absorber column 202 and stripper column 206 as described above. The transfer of heat to the rich amine solution results in the lean amine solution being cooled to approximately 60 degrees Celsius. The trim cooler 210 is arranged to receive the cooled lean amine solution from the amine heat exchanger 204 and is configured to further cool the lean amine solution to approximately 40 degrees Celsius. The further cooling of the lean amine solution is achieved by the trim cooler 210 transferring heat from the lean amine solution to a coolant (e.g. water) as is described below with reference to the feedstock dryer.

From the trim cooler 210, the lean amine solution is passed through a filter to remove any particulates and heat stable solids (or heat stable salts) that may have formed in the solution due to partial degradation of the amine in the reboiler. After filtration, the lean amine solution is returned to the mixing tank 212 which supplies the absorber column 202. In the mixing tank the amine solution is dosed with raw amine, promoter, and pH regulator fluids to maintain the correct ratios. A small make-up water flow is continually added to the mixing tank 212 and a similarly small proportion of the liquid in the mixing tank is continually purged so that the solution is gradually and continually renewed. Nitrogen gas is blanketed above the liquid in the mixing tank 212, to displace oxygen which degrades the amines and to provide a small positive pressure in the tank. To restart the amine cycle 200, liquid from the mixing tank 212 is supplied to the absorber 202 so as to absorb carbon dioxide from the flue gas as described above.

It is noted that the energy required by the flue gas treatment system for removing carbon dioxide from the flue gas is mostly heat and this heat is supplied by the recovery of waste heat from the working fluid of the turbine. Only a negligible amount of electricity is required, both for the flue gas treatment system and for other parasitic loads such as the pump 116 of the generator 100, and as such there is only a minimal energetic penalty to the production of electricity in the systems of the present disclosure. In comparison, electricity-based carbon capture techniques suffer from around a 25% efficiency reduction due to need to use the electricity to produce steam for the carbon capture system.

### Feedstock Drier

FIG. 2 also shows a feedstock drier 124 for the biomass energy generation system 100, which uses waste heat from the flue gas scrubber and the absorption cycle to dry the feedstock 104 before it is used in the pyrolysis reactor 102.

In overview, the feedstock drier 124 comprises means for providing an air flow to the feedstock 104, which in this example is a fan 122, and at least one coolant heat exchanger 120 (analogous to the heat exchanger 26 of FIG. 1) located along the flow path of that air, wherein a coolant is arranged to flow between the at least one coolant heat exchanger 120 and at least one component of the biomass energy generation system 100, such that the coolant absorbs heat from the at least one component of the biomass energy generation system, and the at least one coolant heat exchanger 120 is configured to transfer heat from the coolant to the air flow. In this way, the waste heat from the component(s) of the biomass energy generation system can be used to heat the air flow over the feedstock so as to make use of that waste energy in drying the feedstock 104.

More specifically, in this example waste heat is taken from the following components: the flue gas scrubber 118 of the biomass energy generation system; the trim cooler 210; and the reflux condenser 122 of the flue gas treatment system. A coolant circulation is provided for each of these three components, and each component is configured to transfer heat to the coolant. Respective heat exchangers are provided for each component which are configured to transfer heat from the coolant to the air flow thereby to heat the air before it is used to dry the feedstock. Taking each of these three components in turn:
The flue gas scrubber 118 is arranged to receive the flue gas and to treat the flue gas to remove contaminants such as sulphur dioxide. Therefore, as the flue gas is hot because it comes from the pyrolysis reactor 102, the flue gas scrubber also becomes hot in use and must be cooled. This cooling of the flue gas scrubber 118 is achieved by providing a circulation of a coolant, which in this example is water, between the flue gas scrubber 118 and a flue gas scrubber heat exchanger 214. The flue gas scrubber 118 is arranged to transfer heat from the flue gas to the water coolant, which is then recirculated back to the flue gas scrubber heat exchanger 214. The flue gas scrubber heat exchanger 214 is then arranged to transfer heat from the coolant to the air flow.
The trim cooler 210 is arranged to cool the lean (amine) solution before it enters the mixing tank 212. Therefore, a circulation of a coolant, which in this example is water, is provided between the trim cooler 210 and a trim cooler heat exchanger 216. The trim cooler 210 is arranged to transfer heat from the lean (amine) solution to the water coolant thereby to cool the (amine) solution. The coolant is then recirculated back to the trim cooler heat exchanger 216, and the trim cooler heat exchanger 216 is arranged to transfer the heat from the coolant to the air flow.
The reflux condenser 122 is arranged to cool the gas stream it receives from the stripper column so as to partially dehydrate the gas stream output from the stripper 206 before that gas stream is transferred to the carbon dioxide processing system 300. To dehydrate the gas stream, the reflux condenser is configured to cool the gas stream to condense the vapour present in the gas stream. Therefore, a circulation of a coolant, which in this example is water, is provided between the reflux condenser 122 and a reflux condenser heat exchanger 218. The reflux condenser 122 is arranged to transfer heat from the gas stream to the water coolant thereby to cool the gas stream. The coolant is then recirculated back to the reflux condenser heat exchanger 218, and the reflux condenser heat exchanger 218 is arranged to transfer the heat from the coolant to the air flow.

The air flow is taken form the external ambient environment and is then driven through the flue gas scrubber heat exchanger 214, the trim cooler heat exchanger 216, and the reflux condenser heat exchanger 218 such that it absorbs heat from each heat exchanger along the way. The heated air is then directed over the feedstock 104 thereby to dry the feedstock before it is used in the pyrolysis reactor 102. A fan 122 provides the means for driving the air flow, and in this example the fan 122 is located downstream of the heat exchangers 214, 216, 218 (together: 120) such that the fan pulls air through the heat exchangers, and then pushes that air on to the feedstock.

Therefore, the coolant heat exchangers 120 (comprising the flue gas scrubber heat exchanger 214, the trim cooler heat exchanger 216, and the reflux condenser heat exchanger 218) together with the means for providing the flow of air (which in this example is the fan 122) form a feedstock drier 124 which uses heat from the generator 100, that otherwise would have been wasted, to dry the feedstock. As this heat otherwise would have been wasted, and a separate power source required to power the feedstock dryer, the feedstock drier of the present disclosure increases the efficiency of the biomass energy generation system 100 which in turn reduces the amount of carbon dioxide produced per unit energy generated by the system.

It should be noted that while FIG. 3 shows the use of three sources of waste heat (the flue gas scrubber 119, the trim cooler 210, and the reflux condenser 122), in other examples only one or any other number of sources of waste heat may be used, and these sources may be provided by any other component of the generator 100 or by systems for the generator 100; for example the steam generator 110 may instead provide the heat for the feedstock drier.

Furthermore, FIG. 3 shows the three heat exchangers 214, 216, 218 being arranged in series such that the air flow passes through each of the heat exchangers. This arrangement is advantageous because it provides maximal heating of the air flow. It is further advantageous to arrange the heat exchangers 214, 216, 218 in order to coolest to hottest (in the direction of the air flow) so as to improve the efficiency of heat transfer from the exchangers to the air. Nonetheless, in other examples the heat exchangers may be arranged in parallel, such that air flow is provided in parallel air streams through the heat exchangers.

### Carbon Dioxide Processing

FIG. 4 is a flow diagram of a carbon dioxide processing system 300 for the biomass energy generation system. The carbon dioxide processing system 300 is arranged to receive carbon dioxide removed from the flue gas by the absorption cycle 200 and to process it for use or storage. The use of this carbon dioxide, for example in the food and drink industry, increases the efficiency of the use of the biomass by preventing unnecessary release of carbon dioxide to the atmosphere, both by minimising carbon dioxide emissions in the power generation process and by obviating the need to undertake separate carbon dioxide production for these other purposes.

First, the gas stream from the reflux condenser 122—which comprise carbon dioxide, and which has been partially dehydrated by the reflux condenser 122—is routed from the reflux condenser of the absorption cycle 200 to a carbon dioxide dehydrator 302. The carbon dioxide dehydrator 302 removes residual water vapour remaining in the gas stream (i.e. water that was not removed by the reflux condenser 122) thereby to ‘dry’ the gas stream. The dehydrator 302 comprises columns for removing water vapour from the gas stream by adsorption. The columns operate within a temperature swing adsorption circuit in the dehydrator 302, such that while one of the columns (the ‘dehydrating column(s)’) is actively dehydrating the gas stream, another one of the columns (the ‘regenerating column(s)’) is regenerated. Preferably, the dehydrator 302 comprises two such columns, where one of the columns dehydrates the gas stream while the other is regenerated. To promote the adsorption of water vapour, the gas stream from the reflex condenser 122 is cooled before entering the dehydrating column of the dehydrator 302.

The adsorption of water vapour from the gas stream is achieved by trapping water on adsorbent beads (which are preferably made from 3A zeolite) within the columns. Thereby, water is removed from the gas stream, leaving a dehydrated carbon dioxide gas stream. The dehydrated carbon dioxide exits the dehydrating column at the bottom of the column via a pipe network, with the outflow of carbon dioxide from the column being controlled by a sequence of valves. The outflowing carbon dioxide is also filtered to remove any debris generated from the breakdown of the adsorbent material within the columns.

To regenerate the inactive column (i.e. the column that is not actively dehydrating the gas stream), a portion—approximately 10%—of the dehydrated carbon dioxide leaving the dehydrating column is routed back through the regenerating column via a compressor and heater. The heated carbon dioxide flowing back through the regenerating column causes the adsorbed water to release from the adsorbent beads, thereby regenerating the column. The regeneration of the column results in the release of a stream of water vapour along with the heated carbon dioxide. This stream is then cooled and separated in a knock-out drum. The carbon dioxide gas recovered from the knock-out drum is recycled back into the dehydrator to increase carbon dioxide yield, whilst the liquid condensate (i.e. condensed water) is discarded.

The portion of the dehydrated carbon dioxide from the dehydrator 302 that is not re-circulated through the regenerating column could simply be vented from the system. However, to reduce unnecessary emissions, the carbon dioxide is preferably made use of. For example, the carbon dioxide may be used in an industrial process co-located with the generator 100, or it may be stored for later use or transport.

Therefore, a carbon dioxide offtake system is provided to process the dehydrated carbon dioxide from the dehydrator 302 such that it can either be used immediately or stored for later use or transport. The carbon dioxide offtake system comprises a carbon dioxide compressor 304 and an optional carbon dioxide refrigerator 306. The carbon dioxide compressor 304 is arranged to receive the dehydrated carbon dioxide from the dehydrator 302 and is configured to compress the carbon dioxide to a pipeline pressure for export from the generator 100 to a co-located (i.e. ‘on-site’) industrial process. The carbon dioxide is preferably sequestered by the industrial process so as to minimise the emissions of carbon dioxide to the atmosphere. The pressure to which the carbon dioxide is compressed depends on the requirements of the industrial process in which it will be used.

If the carbon dioxide is not to be used immediately, or if it is to be used off-site such that it must be transported, it is routed from the compressor 304 to a refrigerator 306 for cooling and storage for transport or later use. The refrigerator is configured to cool the compressed carbon dioxide into a liquid phase such that it can be cryogenically stored on-site (i.e. local to the generator 100) for later use or stored between regular off-takes to a tanker for transport. It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A flue gas treatment system for a biomass energy generation system, the flue gas treatment system comprising:
a circulation of solvent for absorbing carbon dioxide from the flue gas;
a heat exchanger located along the flow path of the solvent, for heating the solvent; and
a heat transfer fluid,
wherein the heat transfer fluid is arranged to circulate between the heat exchanger and the biomass energy generation system, such that the heat transfer fluid absorbs heat from a heated fluid of the biomass energy generation system and transfers the heat to the circulation of solvent via the heat exchanger.

2. A system according to claim 1, wherein the heated fluid is a hot air stream for driving a turbine of the biomass energy generation system, preferably wherein the heat transfer fluid is arranged to absorb heat from the air stream downstream of the turbine.

3. A system according to claim 1, wherein the heated fluid of the biomass energy generation system is a flue gas stream from a biomass reactor of the biomass energy generation system.

4. A system according to claim 1, wherein the heat transfer fluid is arranged to absorb heat from the heated fluid of the biomass energy generation system via a further heat exchanger located along the flow path of the heated fluid, and wherein the heat transfer fluid is arranged to circulate between the heat exchanger of the flue gas treatment system and the further heat exchanger.

5. A system according to claim 4, wherein the heat exchanger located along the flow path of the solvent is a reboiler for heating the solvent.

6. A system according to claim 4, wherein the heat transfer fluid is steam, and wherein:
the reboiler is arranged to receive steam from the further heat exchanger located along the flow path of the heated fluid of the biomass energy generation system, and to transfer heat from the steam to the solvent, thereby forming a condensate from the steam; and
the further heat exchanger located along the flow path of the heated fluid of the biomass energy generation system is arranged to receive the condensate from the reboiler, and to transfer heat from the heated fluid of the biomass energy generation system to the condensate, thereby forming the steam.

7. A system according to claim 1, wherein the solvent is an amine.

8. A feedstock drier for a biomass energy generation system, the feedstock drier comprising:
means for providing an air flow to a feedstock for the biomass energy generation system;
at least one heat exchanger located along the air flow path; and
at least one coolant arranged to flow between the at least one heat exchanger
and at least one component of a gas treatment system for the biomass energy generation system,
wherein the at least one coolant is arranged to absorb heat from the at least one component, and wherein the at least one heat exchanger is arranged to transfer the heat from the coolant to the air flow.

9. A feedstock drier according to claim 8, wherein the at least one component comprises a flue gas scrubber, and wherein the coolant is arranged to cool the scrubber by absorbing heat from the scrubber, wherein the flue gas scrubber is located on the flue gas flow path downstream of power and/or heat generation components of the biomass energy generation system.

10. (canceled)

11. A feedstock drier according to claim 8, wherein the at least one component comprises a trim cooler in an absorption cycle for treating flue gas from the biomass energy generation system, and wherein the coolant is arranged to cool the trim cooler by absorbing heat from the trim cooler.

12. A feedstock drier according to claim 8, wherein the at least one component comprises a reflux condenser in an absorption cycle for treating flue gas from the biomass energy generation system, and wherein the coolant is arranged to cool reflux condenser by absorbing heat from the reflux condenser.

13. A feedstock drier according to claim 8, wherein the at least one component comprises multiple components, and wherein:
the at least one heat exchanger comprises a separate heat exchanger for each of the components, and/or
the at least one coolant comprises a separate coolant for each of the components.

14. A feedstock drier according to claim 8, wherein the means for providing an air flow to the feedstock comprises a fan.

15. A feedstock drier according to claim 8, wherein the at least one coolant is water.

16. A biomass energy generation system comprising:
a biomass reactor;
a turbine heat exchanger; and
a flue gas heat exchanger,
wherein the turbine heat exchanger is configured to transfer heat from a flue gas from the biomass reactor to a working fluid for driving a turbine to generate electricity; and
wherein the flue gas heat exchanger is located along the flow path of the flue gas, downstream of the turbine heat exchanger, and is configured to transfer heat from the flue gas to a heat output of the system.

17. A system according to claim 16, comprising a flue gas return pipe for recirculation of the flue gas back into the biomass reactor.

18. A system according to claim 17, wherein the flue gas return pipe is located downstream of the flue gas heat exchanger.

19. A system according to claim 16, comprising a pump for driving the flow of the flue gas, preferably wherein the pump is located on the flue gas flow path downstream of the flue gas heat exchanger.

20. A system according to claim 16, comprising a working fluid heat exchanger located along the flow path of the working fluid, the working fluid heat exchanger configured to transfer heat from the working fluid to a heat output of the system, wherein the working fluid heat exchanger is located along the flow path of the working fluid downstream of the turbine.

21. (canceled)

22. A system according to claim 16, comprising a carbon dioxide processing system, wherein the carbon dioxide processing system is arranged to receive a gas stream comprising carbon dioxide removed from the flue gas, and comprises means for dehydrating the gas stream, preferably wherein the means for dehydrating the gas stream comprises at least one dehydrator column for removing water vapour from the gas stream, preferably by adsorption, wherein the carbon dioxide processing system comprises a compressor downstream of the means for dehydrating, the compressor configured to compress the carbon dioxide, and a refrigerator downstream of the compressor for cooling the carbon dioxide to a liquid state.

23-25. (canceled)
